(19) United States
(12) Patent Application Publication
(10) Pub. No.: US 2017/0259809 A1
(43) Pub. Date: Sep. 14, 2017

(54) CONTROL SYSTEM FOR HYBRID VEHICLE

(71) Applicant: TOYOTA JIDOSHA KABUSHIKI KAISHA, Toyota-shi, Aichi-ken (JP)

(72) Inventor: Yosei SAKAMOTO, Nissin-shi, Aichi-ken (JP)

(73) Assignee: TOYOTA JIDOSHA KABUSHIKI KAISHA, Toyota-shi, Aichi-ken (JP)

(21) Appl. No.: 15/509,324

(22) PCT Filed: Aug. 26, 2015
(86) PCT No.: PCT/JP2015/004277

§ 371 Date: Mar. 7, 2017

(30) Foreign Application Priority Data
Sep. 9, 2014 (JP) 2014-183561

(51) Int. Cl. B60W 20/20; B60K 6/442; B60W 10/06; B60W 10/115; B60W 40/105; B60L 11/18; B60W 10/02; B60W 20/40; B60W 10/08

(52) U.S. Cl. CPC B60W 20/20; B60W 20/40; B60K 6/442; B60W 10/06; B60W 10/08; B60W 40/105; B60L 11/1861; B60W 10/02; B60W 10/115; B60W 2510/244; B60W 2520/10; B60W 2550/142; Y10S 903/905; Y10S 903/906; Y10S 903/907; B60W 2510/246; B60W 2710/083; B60W 2510/08; B60W 2510/06; B60W 2710/06; B60K 6/26

(57) ABSTRACT

A control system for a hybrid vehicle configured to avoid unintentional reduction in a driving force is provided. The control system is configured to estimate a vehicle speed after a predetermined period of time during propulsion of the vehicle under single-motor mode, and to shift the operating mode directly from the single-motor mode to an engine mode while skipping a dual-motor mode, if a current operating point of the vehicle enters into an operating region where both of the second mode and the third mode are available but the operating mode is expected to be further shifted to the engine mode.

### TECHNICAL FIELD

The present invention relates to a control system for a hybrid vehicle which controls a prime mover including an engine as well as a motor(s) or a motor/generator(s), more specially, to a control system for a hybrid vehicle configured to switch an operating mode of the vehicle.

### BACKGROUND ART

JP-A-2008-265598 and JP-A-2000-023310 disclose powertrains of a dual-motor hybrid vehicle comprising a motor/generator used to control an engine speed and a motor driven by electric power generated by the motor/generator. In the hybrid powertrain of this kind, the engine and the motor/generators are connected respectively to a power distribution device adapted to perform a differential action among three rotary elements. The motor is connected to an output element of the power distribution device, and the output element is also connected to driving wheels through a gear train. The motor/generator is electrically connected with the motor to deliver the generated electricity to the motor.

During propelling the vehicle by the engine, that is, under hybrid mode (or engine mode), a negative torque resulting from rotating the driving wheels is applied to the output element of the power distribution device. In this situation, the engine speed can be adjusted by changing a rotational speed of the motor/generator to operate the engine in an optimally fuel efficient manner, and the motor can be activated by the resultant electricity of the motor/generator to assist to rotate the driving wheels.

According to the teachings of JP-A-2008-265598 and JP-A-2000-023310, the hybrid vehicle can be propelled under motor mode in which the vehicle is allowed to be powered only by the motor(s) while cutting off fuel supply to the engine. Specifically, the motor mode may be selected from single-motor mode in which the vehicle is powered only by the motor connected to the output element, and dual-motor mode in which the vehicle is powered by the motor and the motor/generator. In the hybrid powertrain of this kind, an output shaft can be fixed by a fixing means so that the power distribution device can serve as a speed changing mechanism. In this case, an input element of the power distribution device can be fixed by fixing the output shaft of the engine thereby changing torque of the motor/generator in accordance with gear ratio of the power distribution device. In this situation, the driving wheels are driven by driving forces of the motor/generator and motor by activating the motor together with motor/generator.

Under the motor mode, the engine being stopped can be started utilizing torque of the motor/generator. However, when operating mode is shifted from the dual-motor mode to the engine mode, output torque of the motor/generator for rotating the driving wheels has to be consumed to crank the engine. Consequently, the driving force for rotating the driving wheels would fall short and hence driver may feel discomfort. In order to avoid such disadvantage, according to the teachings of JP-A-2000-023310, cranking of the engine is started after reducing output torque of the motor, and the output torque of the motor thus reduced is then increased again to avoid reduction in the driving force.

### SUMMARY OF INVENTION

### Technical Problem

Under the dual-motor mode, larger driving force can be generated by the motors and hence the vehicle is allowed to be propelled at higher speed in comparison with the single-motor mode. That is, the operating mode is shifted from the single-motor mode to the dual-motor mode with an increment of required driving force or vehicle speed. Likewise, the driving force and the vehicle speed can be further increased under the engine mode, and hence the operating mode is shifted from the dual-motor mode to the engine mode with a further increment of the required driving force or vehicle speed.

As described, the drive mode is shifted in order from the single-motor mode to the engine mode via the dual-motor mode with an increment of the required driving force or vehicle speed.

As also described, when the engine is cranked by the motor/generator in the conventional hybrid powertrain taught by the prior art documents during shifting the operating mode from the dual-motor mode to the engine mode, the driving force for rotating the driving wheels would drop and hence driver may feel discomfort.

The present invention has been conceived noting the foregoing technical problems, and it is therefore an object of the present invention is to provide a control system for a hybrid vehicle configured to avoid unintentional reduction in a driving force for rotating a driving wheels during shifting the operating mode from a motor mode to an engine mode.

### Solution to Problem

The control system according to the present invention is applied to a hybrid vehicle having an engine and at least a pair of motors. The control system is configured to select an operating mode of the vehicle from a first mode in which the vehicle is powered by the engine, a second mode in which the vehicle is powered by at least two of the motors while stopping the engine, and a third mode in which the vehicle is powered by smaller numbers of the motors than that under the second mode while stopping the engine, and to carry out a motoring of the engine by the first motor that generates driving force under the second mode but that does not generate driving force under the third operating mode, when shifting the operating mode from the second mode or the third mode to the first mode. In order to achieve the above-explained objective, according to the present invention, the control system is further configured to estimate a vehicle speed after a predetermined period of time during propulsion of the vehicle under the third mode; to determine whether or not an operating point of the vehicle determined based on an estimated vehicle speed and a current driving force will enter into a region where the vehicle can be propelled only under the first mode; and to shift the operating mode directly from the third mode to the first mode while skipping the second mode, if the current operating point of the vehicle determined based on a current vehicle speed and a current driving force enters into an operating region where both of the second mode and the third mode are available, but the operating point is expected to further enter into the region where the vehicle can be propelled only under the first mode.

The predetermined period of time may include a possible time period to propel the vehicle under the second mode.

The control system is further provided with an electric storage device that delivers electricity to the motors. In addition, the predetermined period of time includes a possible time period of the electric storage device to continue to output an effective maximum power thereof to propel the vehicle under the second mode.

The possible time period of the electric storage device to continue to output an effective maximum power may be determined based on an SOC level thereof or a temperature thereof.

The control system is further configured to estimate the vehicle speed after the predetermined period based on a current driving force, a current vehicle speed, and a current road gradient.

A boundary between the operating region where the third mode is selected and the operating region where the second mode or the third mode is selected is determined in such a manner that one of the motors is still allowed to increase an output torque thereof to compensate a reduction in the driving force resulting from cranking the engine by the first motor to shift the operating mode to the first mode.

The vehicle is allowed to be propelled by a larger driving force at a higher speed under the first mode than those under the second mode or the third mode, and allowed to be propelled by a larger driving force at a higher speed under the second mode than those under the third mode.

The control system is further provided with: a power distribution device having at least three rotary elements including a first rotary element; and an engagement device that halts a rotation of the first rotary element. Any one of the motors that generates driving force under the second and the third modes is connected to any of rotary element other than the first rotary element.

The first motor may be connected to the first rotary element.

### Advantageous Effects of Invention

Thus, according to the present invention, the operating mode of the vehicle may be selected from the first mode in which the vehicle is powered by the engine, the second mode in which the vehicle is powered by at least two of the motors while stopping the engine, and the third mode in which the vehicle is powered by smaller numbers of the motors than that under the second mode while stopping the engine. As described, the control system is configured to estimate a vehicle speed after a predetermined period of time during propulsion of the vehicle under the third mode. If the current operating point of the vehicle based on the current vehicle speed and the current driving force enters into the operating region where both of the second and the third modes are available and the operating point is expected to further enter into the region where the vehicle can be propelled only under the first mode, the control system shifts the operating mode directly from the third mode to the first mode while skipping the second mode. In this case, the control system carries out a motoring of the vehicle by the first motor that generates driving force under the second mode but that does not generate driving force under the third operating mode. According to the present invention, therefore, the operating mode will not be shifted from the second mode to the first mode so that the reduction in the driving force resulting from cranking the engine by the first motor under the second mode can be prevented.

### BRIEF DESCRIPTION OF DRAWINGS

FIG. 1 is a flowchart showing a control example according to the present invention.

FIG. 2 is a skeleton diagram schematically showing an example of the hybrid vehicle to which the control system of the invention is applied.

FIG. 3 is a block diagram showing the control system according to the present invention.

FIG. 4 is a map for selecting the operating mode of the hybrid vehicle.

FIG. 5 is a skeleton diagram schematically showing another example of the hybrid vehicle to which the control system of the invention is applied.

FIG. 6 is a skeleton diagram schematically showing a still another example of the hybrid vehicle to which the control system of the invention is applied.

FIG. 7 shows nomographic diagrams and engagement tables of the rotary members under each drive mode in the vehicle shown in FIG. 6.

### DESCRIPTION OF EMBODIMENTS

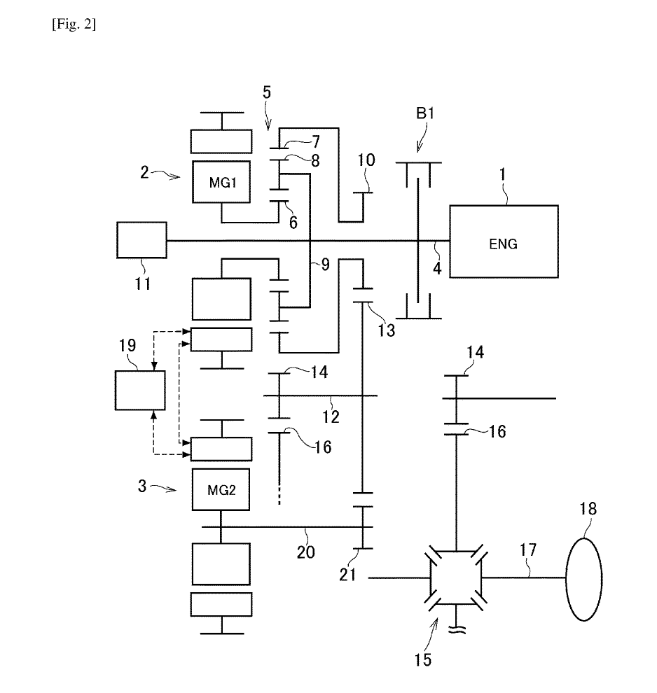

Referring now to FIG. 2, there is shown a first example of a hybrid vehicle to which the control system of the preferred example is applied. The hybrid vehicle shown in FIG. 2 comprises a prime mover including an engine 1 (referred as “ENG” in FIG. 2) and first and second motor/generators 2 and 3 (referred as “MG1” and “MG2” in FIG. 2). The hybrid vehicle can be operated under suitable operating mode selected among engine mode where the vehicle is powered by the engine 1, dual-motor mode where the vehicle is powered by the first and the second motor/generators 2 and 3 while stopping engine 1, and single-motor mode where the vehicle is powered by any one of the first and the second motor/generators 2 and 3 while stopping engine 1.

An output shaft 4 of the engine 1 is connected to a power distribution device 5. The power distribution device 5 is a single-pinion planetary gear unit adapted to perform a differential action among three rotary elements. The power distribution device 5 comprises a first sun gear 6 fitted onto an output shaft 4 while being allowed to rotate relatively therewith, a first ring gear 7 arranged concentrically with the first sun gear 6, first pinion gears 8 interposed between the first sun gear 6 and the first ring gear 7 while meshing therewith, and a first carrier 9 supporting the first pinion gears 8 while allowing to rotate and revolve around the first sun gear 6. The first carrier 9 is connected to the output shaft 4 of the engine 1, the first sun gear 6 is connected to the first motor/generator 2, and the first ring gear 7 is connected to a drive gear 10, respectively. The first carrier 9 of the power distribution device 5 serves as the claimed first rotary element.

In order to establish hydraulic pressure and to deliver lubricant to a lubrication site, an oil pump 11 is also connected to the output shaft 4 to be driven by the engine 1.

A countershaft 12 is arranged parallel to the output shaft 4. A counter driven gear 13 diametrically larger than the drive gear 10 is formed on one end of the countershaft 12 to be meshed with the drive gear 10 so that the torque transmitted from the drive gear 10 is multiplied. A counter drive gear 14 is formed on the other end of the countershaft 12 to be meshed with a ring gear 16 of a differential gear unit 15. An inner end of each drive shaft 17 is individually connected to the differential gear unit 15, and an outer end of each drive shaft 17 is connected to driving wheel 18. In FIG. 2, the differential gear unit 15 and auxiliaries are shifted to the right side in FIG. 2 for the convenience of illustration.

When a torque of the engine 1 is applied to the power distribution device 5 to rotate the first ring gear 7, the first motor/generator 2 can establish a reaction torque to counteract the torque applied to the first sun gear 6 from the engine 1 via the first carrier 9. That is, the first sun gear 6 serves as a reaction element. Both rotational speed and output torque of the first motor/generator 2 are changeable. On the occasion of thus establishing the reaction torque by the first motor/generator 2, it is preferable to adjust a rotational speed of the first motor/generator 2 in such a manner that the engine 1 can be operated in an optimally fuel efficient manner.

In case of establishing the reaction torque by the first sun gear 6, torque to be generated by the first motor/generator 2 is determined in accordance with the output torque of the engine 1, and rotational speed as well as a rotational direction of the first motor/generator 2 are determined in accordance with a target rotational speed of the engine 1. That is, during propelling the vehicle by the engine 1, the first motor/generator 2 serves not only as a motor but also as a generator. For example, when an absolute value of the rotational speed of the first motor/generator 2 is lowered by the engine torque, the first motor/generator 2 is allowed to generate electric power. By contrast, when the first motor/generator 2 generates torque by increasing the rotational speed thereof, power of the first motor/generator 2 is added to power of the engine 1 to rotate the driving wheels 18.

Thus, the first motor/generator 2 is operated in such a manner that the engine 1 can be operated in an optimally fuel efficient manner, and in this situation, power of the engine 1 delivered to the power distribution device 5 is changed. Consequently, if the power of the engine 1 is outputted from the power distribution device 5 while being reduced, such reduction in power is compensated by the second motor/generator 3. By contrast, if the power of the engine 1 is outputted from the power distribution device 5 while being increased, surplus of power is used to generate electricity by the second motor/generator 3. That is, in case the first motor/generator 2 is operated as a generator, the electric power generated by the first motor/generator 3 is delivered to the second motor/generator 3 to drive the second motor/generator 3 as a motor. By contrast, in case the first motor/generator 2 is operated as a motor, the first motor/generator 2 is driven by electric power generated by the second motor/generator 3. To this end, the first and second motor/generators 2 and 3 are electrically connected with an electric storage device 19 such as a battery and a capacitor via a not shown controller such as an inverter. The power of the storage device 19 can be supplied e.g., to the motor/generators 2 and 3, and the storage device 19 can be charged with the electric powers generated by the motor/generators 2 and 3.

An output shaft 20 of the second motor/generator 3 is arranged parallel to the countershaft 12. A reduction gear 21 diametrically smaller than the counter driven gear 13 is formed on one end of the output shaft 20 to be meshed with the counter driven gear 13 so that the torque transmitted from the second motor/generator 3 to the driving wheels 18 can be multiplied.

The operating mode in which the vehicle is thus powered by the engine 1 will be called as the engine mode corresponding to the claimed first operating mode. When required driving force is relatively small, the vehicle may also be powered by the second motor/generator 3 while stopping the engine 1 by stopping fuel supply thereto. The operating mode in which the vehicle is powered by the second motor/generator 3 will be called as the single-motor mode corresponding to the claimed third operating mode.

In the single-motor mode, since the vehicle is powered only by the second motor/generator 3, maximum possible driving force under the single-motor mode is relatively small. However, when relatively large driving force is required e.g., to accelerate the vehicle, it is also possible to generate the required driving force of the vehicle by the first and the second motor/generators 2 and 3. To this end, a first brake B1 serving as the claimed engagement device is arranged in the hybrid vehicle shown in FIG. 2 to deliver the power of the first motor/generator 2 to the driving wheels 18 by selectively stopping rotation of the output shaft 4 of the engine 1. For example, a dog brake, a friction brake etc. actuated by a hydraulic actuator or an electromagnetic actuator may be used as the first brake B1. Specifically, the first brake B1 is fixed to a not shown steady casing, and brought into engagement to stop the rotation of the output shaft 4 of the engine 1. The operating mode in which the vehicle is thus powered by both the first and the second motor/generators 2 and 3 will be called as the dual-motor mode corresponding to the claimed second operating mode.

When the first motor/generator 2 generates a torque while bringing the first brake B1 into engagement, the first sun gear 6 serves as an input element and the first carrier 9 serves as a reaction element so that the output torque of the first motor/generator 2 can be delivered to the driving wheels 18. When the vehicle is propelled by the torque of the first motor/generator 2 in the forward direction, a counter torque is applied to the output shaft 4. Therefore, the first brake B1 may be adapted to be brought into engagement with the casing when the counter torque is applied to the output shaft 4.

As described, the operating mode is shifted from the single-motor or the dual-motor mode to the engine mode based on a change in a running condition. For example, the operating mode is shifted to the engine mode when a required driving force is increased, or when an SOC (State of charge) of the electrical power storage device 19 is lowered to a predetermined level. In those cases, the engine 1 is cranked by the first motor/generator 2 while releasing the first brake B1. That is, the first motor/generator 2 serves as a starter motor.

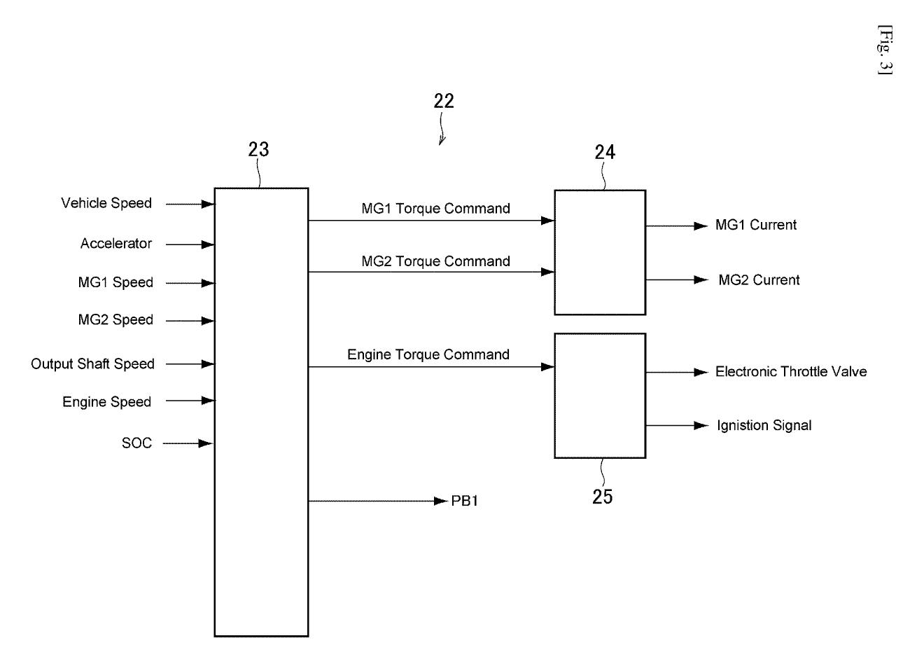

In order to control the engine 1, the motor/generators 2 and 3, and the first brake B1, the hybrid vehicle shown in FIG. 2 is provided with an ECU (electronic control unit) 22 serving as a controller. Turning to FIG. 3, there is shown a control system of the hybrid vehicle shown in FIG. 2. The ECU 22 comprises a hybrid control unit (as will be called the “HV-ECU” hereinafter) 23 for entirely controlling a running condition of the vehicle, a motor/generator control unit (as will be called the “MG-ECU” hereinafter) 24 for controlling the first and second motor/generators 2 and 3, and an engine control unit (as will be called the “ENG-ECU” hereinafter) 25 for controlling the engine 1. Each of the control unit 23, 24 and 25 are individually composed mainly of a micro-computer configured to carry out a calculation based on input data and preinstalled data, and to output a calculation result in the form of a command signal. For example, a vehicle speed, an opening degree of the accelerator, a rotational speed of the first motor/generator 2, a rotational speed of the second motor/generator 3, a rotational speed of the first ring gear 7 (i.e., an output shaft speed), a rotational speed of the engine 1, an SOC of the storage device 19 and so on are sent to the HV-ECU 23. Meanwhile, the HV-ECU 23 is configured to transmit a torque command for the first motor/generator 2, a torque command for the second motor/generator 3, a torque command for the engine 1, a hydraulic pressure command for controlling the first brake B1 and so on.

The torque command for the first motor/generator 2 and the torque command for the second motor/generator 3 are sent to the MG-ECU 24, and the MG-ECU 24 calculates current commands to be sent individually to the first motor/generator 2 and the second motor/generator 3 using those input data. Meanwhile, the torque command for the engine 1 is sent to the engine-ECU 25, and the ENG-ECU 25 calculates a command to control an opening degree of the electronic throttle valve and a command to control an ignition timing using those input data.

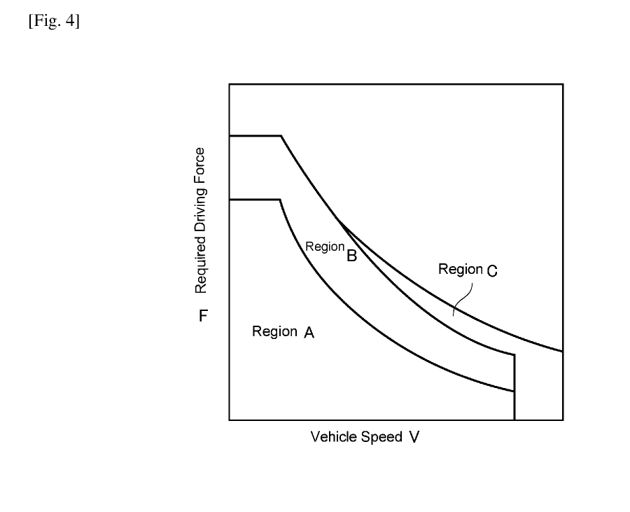

A map for selecting a suitable operating mode in accordance with operation state based on a required driving force and a vehicle speed is preinstalled in the HV-ECU 23. FIG. 4 shows an example of a map used to select the suitable operating mode, and in FIG. 4, the horizontal axis represents a vehicle speed V, and the vertical axis represents a required driving force F respectively. The required driving force F can be calculated based on an opening degree of accelerator and a vehicle speed. The single-motor mode is selected when the required driving force F and the vehicle speed V fall within an operating region A. That is, the single-motor mode is selected when the required driving force F is relatively small and the vehicle speed V is relatively low. In contrast, the engine 1 can generate larger driving force than that generated by the first and second motor/generators 2 and 3 to propel the vehicle at a higher speed. That is, in case of propelling the vehicle at a speed within an operating region C that is higher than the region A, the engine mode is selected. If the required driving force F and the vehicle speed V fall within an operating region B situated between region A and region C, the vehicle can be propelled not only under the dual-motor mode within a predetermined period of time, but also under the engine mode. In case the required driving force F and the vehicle speed V fall within the region B, therefore, the operating mode of the vehicle is selected from the dual-motor mode and the engine mode by the following procedures.

When the cranking of the engine 1 is carried out by the first motor/generator 2 during propelling the vehicle under the single-motor mode, a reaction torque resulting from cranking the engine 1 is applied to the driving wheels 18. In order to prevent reduction in the driving force for rotating the driving wheels 18 by the reaction torque applied to the driving wheels 18, that is, to compensate a braking force acting as to reduce the driving force, a torque generated by the second motor/generator 3 is increased. Specifically, a boundary between the region A where the single-motor mode is selected and the region B where the dual-motor mode or the engine mode is selected is determined in such a manner that the second motor/generator 3 is still allowed to increase an output torque thereof to compensate the reduction in the driving force resulting from the cranking of the engine 1 by the first motor/generator 2 to shift the operating mode to the engine mode. A boundary between the region B and the region C where the engine-mode is selected is determined based on a total maximum output power of the first motor/generator 2 and the second motor/generator 3.

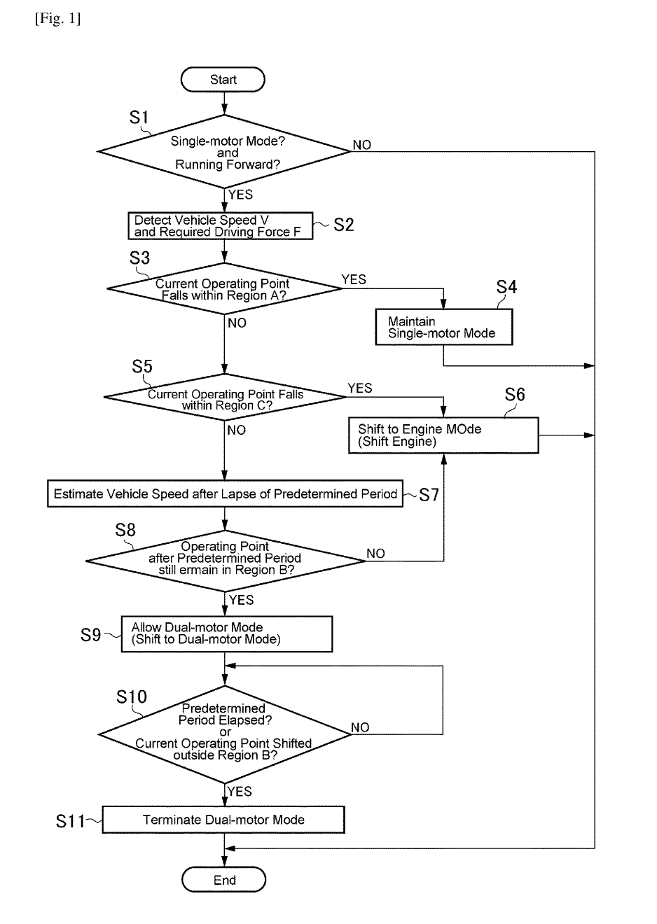

Referring now to FIG. 1, there is shown an example of selecting suitable operating mode in the region B. The routine shown in FIG. 1 is commenced when the operating point of the vehicle being accelerated enters into the region B, and repeated at predetermined time interval. At step S1, it is determined whether or not the vehicle is running forward under the single-motor mode. Specifically, the determination of the single-motor mode can be made based on whether or not electric power is supplied only to the second motor/generator 3 while stopping fuel supply to the engine 1, and the determination of forward running can be made based on whether or not the shift lever is in “D” position. Alternatively, the determination of the single-motor mode may also be made based on whether or not the engine 1 is activated in response to the incident command signal from the EG-ECU 25, and whether or not a drive command signal from the MG-ECU 24 is sent only to the second motor/generator 3.

If the single-motor mode is not selected or if the vehicle is running backwardly so that the answer of step S1 is NO, the routine is ended without carrying out any specific control. By contrast, if the vehicle is running forward under the single-motor mode so that the answer of step S1 is YES, a current vehicle speed V and a current driving force F are detected at step S2. Then, at step S3, it is determined whether or not an operating point of the vehicle based on the vehicle speed V and the required driving force F detected at step S2 falls within the region A shown in FIG. 4. If the operating point falls within the region A so that the answer of step S3 is YES, the vehicle is operated under the single-motor mode continuously at step S4, and then the routine is ended. In this situation, the second motor/generator 3 is controlled in such a manner to achieve the driving force F to propel the vehicle.

By contrast, if the operating point falls outside the region A so that the answer of step S3 is NO, then it is determined at step S5 whether or not the operating point falls within the region C. If the operating point falls within the region C so that the answer of step S5 is YES, the operating mode is shifted to the engine mode at step S6, and then the routine is ended. In this case, specifically, the engine 1 is cranked by the first motor/generator 2, and the output power of the second motor/generator 3 is increased to prevent a reduction in the driving force during cranking of the engine 1. Then, when the rotational speed of the engine 1 reaches a predetermined speed, the engine 1 is started and controlled in such a manner to generate the required driving force F. In this situation, since the power generated by the second motor/generator 3 is increased during cranking the engine 1, the driving force will not drop during shifting from the single-motor mode to the engine mode.

If the operating point falls outside the region C but falls within the region B so that the answer of step S5 is NO, an expected vehicle speed Va to be achieved after a lapse of predetermined time period by maintaining the current driving force F is estimated at step S7. The expected vehicle speed Va estimated at step S7 is used to determine whether or not the vehicle speed V enters into the region C within a possible time period to propel the vehicle under the dual-motor mode. Under the dual-motor mode, the vehicle is powered by both the first and the second motor/generators 2 and 3 while supplying maximum electric power thereto from the storage device 19. However, a possible time period of the storage device 19 to output the effective maximum power is limited. For this reason, the predetermined time period used at step S7 is determined based on the possible time period of the storage device 19 to continue to output the effective maximum power thereof so as to propel the vehicle under the dual-motor mode. Such possible time period of the storage device 19 to continue to output the effective maximum power thereof is varied depending on an SOC level thereof, a temperature thereof and so on. Therefore, the predetermined time period used at step S7 may be changed based on those conditions.

At step S7, specifically, the expected vehicle speed Va to be achieved after a lapse of the predetermined time period by maintaining the current driving force F is estimated based on the current vehicle speed V, the current required driving force F and a road gradient θ. Here, it is to be noted that the expected vehicle speed Va is estimated based on the assumption that the required driving force F and the road gradient θ are constant. To this end, the road gradient θ may be detected by an acceleration sensor. Instead, the road gradient θ may also be estimated based on an acceleration calculated based on a prior required driving force F (n-1) and a prior vehicle speed V (n-1) detected during the preceding routine. Further, the road gradient θ may also be detected by a navigation system.

Then, at step S8, it is determined whether or not the operating point based on the expected vehicle speed Va after the predetermined period estimated at step S7 and the current driving force F still remains within the region B. If such expected operating point of the accelerating vehicle after the predetermined period will fall outside the region B so that the answer of step S8 is NO, this means that the operating point will enter into the region C after the lapse of the predetermined period. That is, at step S8, it is also possible to determine whether or not the expected operating point of the accelerating vehicle after the predetermined period will fall outside the region C.

Thus, the region B is situated between the region A and the region B, and hence the operating mode is shifted from the single-motor mode to the engine mode via the dual-motor mode. However, if the engine 1 is started by the first motor/generator 2 under the dual-motor mode, torque of the first motor/generator 2 cannot be used to propel the vehicle and therefore the driving force drops temporarily. In addition, the driving force is also dropped by a reaction torque resulting from cranking the engine 1 that is applied to the driving wheels 18.

In order to avoid such reduction in the driving force, if the operating point will enter into the region C after the predetermined period so that the answer of step S8 is NO, the routine is returned to step S6 to shift the operating mode of the vehicle directly to the engine mode while inhibiting the dual-motor mode. In this case, specifically, the engine 1 is started to generate the current required driving force F. In this situation, one of the motor/generator 2 and 3 is operated as a generator, and the other motor/generator 2 or 3 is operated as a motor.

By contrast, if the operating point of the vehicle estimated at step S7 is expected to remain within the region B even after the lapse of the predetermined period so that the answer of step S8 is YES, the vehicle is allowed at step S9 to be propelled under the dual-motor mode for the above-explained possible time period. In this case, specifically, the first brake B1 is brought into engagement to hold the output shaft 4, while allowing the first motor/generator 2 to generate driving force and the storage device 19 to output the maximum power.

Then, at step S10, it is determined whether or not the predetermined time period has elapsed, or whether or not the current operating point is shifted outside the region B. If the predetermined time period has not yet elapsed, or if the current operating point still remains within the region B so that the answer of step S10 is NO, such determination of step S10 is repeated until those conditions are satisfied.

By contrast, if the predetermined time period has elapsed, or the current operating point has been shifted outside the region B so that the answer of step S10 is YES, the dual-motor mode is terminated at step S11, and the routine is ended. In case of terminating the dual-motor mode after the lapse of the predetermined time period, it is preferable to lower the driving force smoothly to prevent discomfort.

Thus, when the operating point of the vehicle is shifted from the region A where the vehicle is propelled under the single-motor mode to the region B, the operating mode is selected while estimating the operating point after a lapse of the predetermined period, and the dual-motor mode is inhibited selectively depending on the expected operating mode of the vehicle. For this reason, reduction in the driving force resulting from cranking the engine 1 by the first motor/generator 2 under the dual-motor mode can be prevented to reduce discomfort when shifting the operating mode. In addition, if the dual-motor mode is not expected to be shifted to the engine mode, the dual-motor mode can be continued to propel the vehicle within the possible time period so that the fuel can be saved. Basically, a time period in which the vehicle is accelerated is shorter than the above-explained possible time to continue the dual-motor mode. According to the preferred example, therefore, the operating mode of the vehicle is basically not shifted from the dual-motor mode to the engine mode so that the reduction in the driving force will not be caused by cranking the engine under the dual-motor mode with rare exceptions.

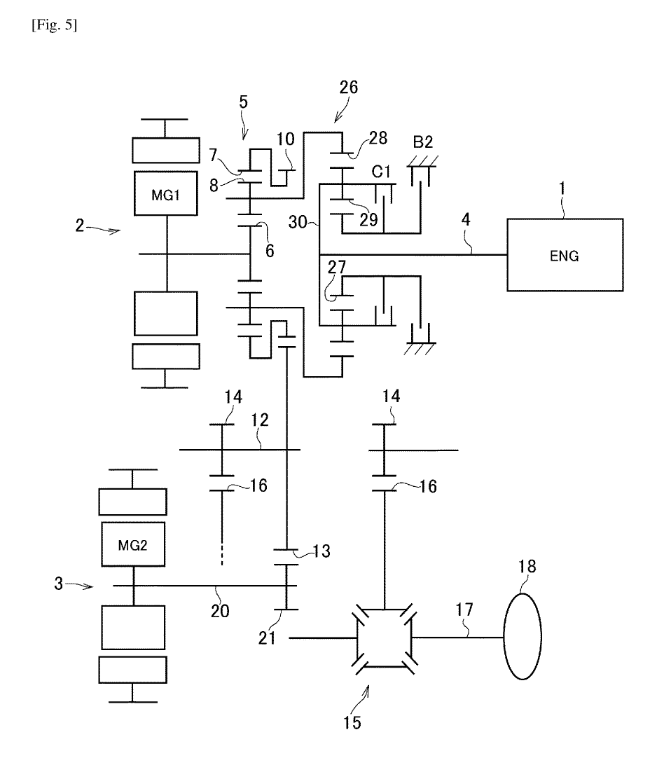

In the vehicle shown in FIG. 2, the first motor/generator 2 would be operated as a motor at high speed range when adjusting the engine speed by the first motor/generator 2. In this situation, the second motor/generator 3 is operated as a generator and hence a power circulation would be caused in the vehicle. Turning now to FIG. 5, there is shown another example of the hybrid vehicle to prevent such power circulation. In the vehicle shown in FIG. 5, a transmission 26 adapted to shift a gear stage is disposed between the engine 1 and the power distribution device 5, and remaining structure of the vehicle shown in FIG. 5 is similar to that of the vehicle shown in FIG. 2. In FIG. 5, common reference numerals are allotted to the elements in common with those of the vehicle shown in FIG. 2, and detailed explanation for those common elements will be omitted.

In the vehicle shown in FIG. 5, the transmission 26 as a single-pinion planetary gear unit is connected to the output shaft 4 of the engine 1. The transmission 26 comprises: a second sun gear 27 fitted onto the output shaft 4 of the engine 1 while being allowed to rotate relatively therewith; a second ring gear 28 arranged concentrically with the second sun gear 27 and connected to the first carrier 9 of the power distribution device 5; second pinion gears 29 meshing with the second sun gear 27 and the second ring gear 28; and a second carrier 30 connected to the output shaft 4 of the engine 1 while supporting the second pinion gears 29 in a rotatable and revolvable manner. The transmission 26 is further provided with a first clutch C1 adapted to halt the second sun gear 27 and the first carrier 9 selectively, and a second brake B2 adapted to halt the second sun gear 27 selectively.

In the transmission 26, a gear stage where a speed ratio is “1” is established by bringing the first clutch C1 into engagement, and a gear stage where a speed ratio is smaller than “1” is established by bringing the second brake B2 into engagement. In the vehicle shown in FIG. 5, the second ring gear 28 and the engine 1 can be stopped by bringing both of the first clutch C1 and the second brake B2 into engagement. When the vehicle speed is increased to a relatively high speed during propelling the vehicle under the engine mode, an input speed to the power distribution device 5 can be increased by bringing the first clutch C1 into disengagement while bringing the second brake B2 into engagement. Consequently, the first motor/generator 3 can be prevented from being operated as a motor.

That is, under the dual-motor mode, the first carrier 9 of the power distribution device 5 can be stopped by bringing both of the first clutch C1 and the second brake B2 into engagement so that the torque of the first motor/generator 2 can be delivered to the driving wheels 18. In other words, a reaction force against the driving force of the first motor/generator 2 can be established by the transmission 26 as the first brake B1 shown in FIG. 2.

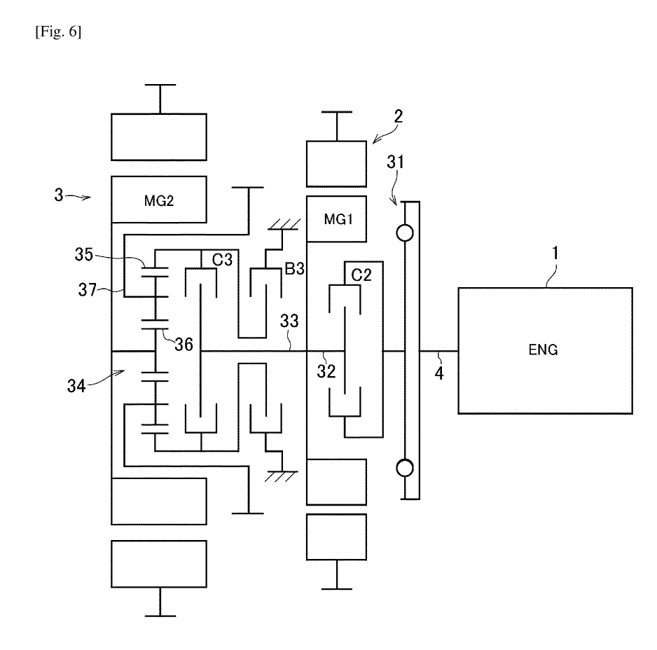

Thus, the vehicles shown in FIGS. 2 and 5 are provided with the power distribution device 5 comprising the first carrier 9 to which the engine torque is applied, the first sun gear 6 connected to the first motor/generator 2, and the first ring gear 7 connected to the driving wheels 18. However, the control system according to the preferred example may also be applied to a vehicle that does not have the power distribution device 5 as shown in FIG. 6. In the vehicle shown in FIG. 6, a second clutch C2 is connected to the output shaft 4 of the engine 1 through a damper 31, and the first motor/generator 2 is connected to an output shaft 32 of the second clutch C2. A single-pinion planetary gear unit 34 is connected to an output shaft 33 of the first motor/generator 2 through a third clutch C3. Specifically, in the planetary gear unit 34, a third ring gear 35 is connected to the output shaft 33 of the first motor/generator 2 through the third clutch C3, a third sun gear 36 is connected to the second motor/generator 3, and a third carrier 37 is connected to the driving wheel through a not shown gear train. The vehicle shown in FIG. 6 is further provided with a third brake B3 to selectively halt the third ring gear 35.

As the vehicles shown in FIGS. 2 and 5, the operating mode of the vehicle shown in

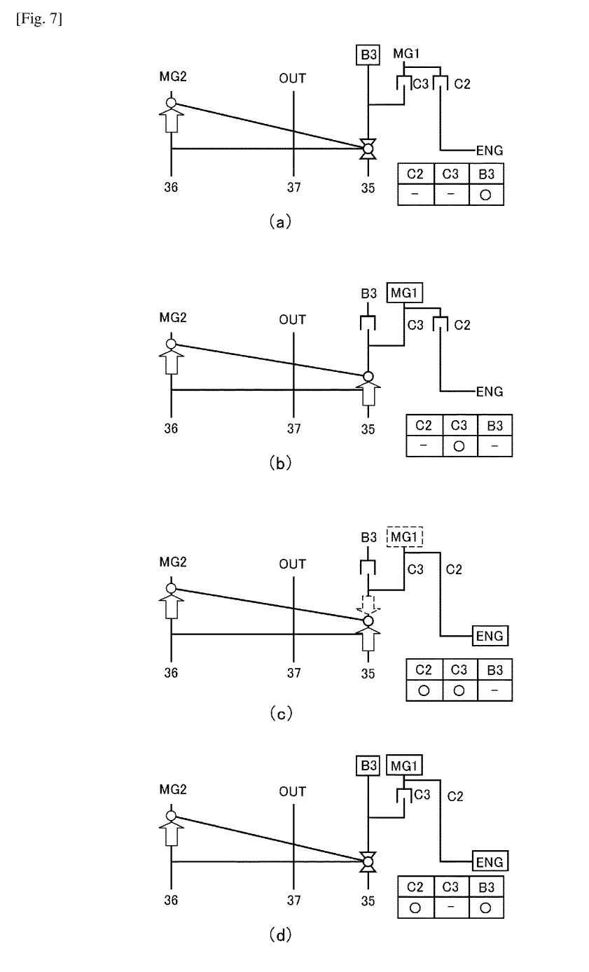

FIG. 6 may also be selected from the engine mode, the single-motor mode, and the dual-motor mode, and the engine 1 may also be started by the first motor/generator 2. Turning to FIG. 7, there are shown nomographic diagrams indicating situations of the planetary gear unit 34 and engagement tables indicating engagement states of the engagement devices C2, C3 and B3 in each situation. In the nomographic diagrams, arrows represent directions of torques applied to the rotary elements. In the tables, “O” represents an engagement of the element, and “-” represents a disengagement of the element.

FIG. 7(a) shows situations of the rotary elements of the planetary gear unit 34 under the single-motor mode. As described, the third sun gear 36 is connected to the second motor/generator 3, and under the single-motor mode, the vehicle is powered only by the second motor/generator 3. To this end, the third brake B3 is arranged to use the third ring gear 35 as a reaction element. Under the single-motor mode, specifically, driving force for propelling the vehicle is generated by the second motor/generator 3 while bringing the third brake B3 into engagement, and the vehicle is propelled by the torque of the third carrier 37.

By contrast, under the dual-motor mode, the vehicle is powered by both of the first and the second motor/generators 2 and 3. In the example shown in FIG. 6, the first motor/generator 2 is connected to the third ring gear 35 through the second clutch C2. Under the dual-motor mode, specifically, the third clutch C3 is brought into engagement and the third brake B3 is brought into disengagement. In this situation, as shown in FIG. 7 (b), the third carrier 37 is rotated by a total torque of the first and the second motor/generator 2.

In turn, under the engine mode, the second clutch C2 and the third clutch C3 are brought into engagement to deliver the engine torque to the third ring gear 35. In this case, as shown in FIG. 7 (c), the second motor/generator 3 establishes a reaction torque to deliver the engine torque from the planetary gear unit 34 to the driving wheels. In this situation, the first motor/generator 3 may be driven not only to suppress the engine torque delivered to the planetary gear unit 34 but also to multiply the engine torque delivered to the planetary gear unit 34. Here, in FIG. 7 (c), the arrow illustrated by the broken line indicates the torque of the first motor/generator 2 generated in a direction to suppress the engine torque delivered to the planetary gear unit 34.

As described, the vehicle shown in FIG. 6 can be propelled by the power of the second motor/generator 3 by bringing the third brake B3 into engagement. In this case, the engine 1 and the first motor/generator 2 can be connected to exchange torque therebetween by bringing the second clutch C2 into engagement. That is, under the situation where the vehicle is powered by the second motor/generator 3 while bringing the second clutch C2 into engagement as shown in FIG. 7 (d), the cranking of the engine 1 can be carried out by the first motor/generator 2 while bringing the second clutch C2 into engagement.

Thus, in the vehicle shown in FIG. 6, the foregoing operating modes can be established and the engine 1 can be started by the first motor/generator 2. When carrying out the cranking of the engine 1, the third clutch C3 is thus brought into disengagement in order not to apply the reaction torque resulting from cranking the engine 1 to the driving wheels. In this situation, however, the torque of the first motor/generator 2 cannot be delivered to the driving wheels. That is, when cranking the engine 1 by the first motor/generator 2 under the dual-motor mode, the first motor/generator 2 that has been used to generate the driving force of the engine 1 is used to start the engine 1, and consequently a shortage of the driving force to propel the vehicle would be caused. In order to avoid such disadvantage, according to the preferred example, the operating mode is shifted directly to the engine mode from the single-motor mode while skipping the dual-motor mode in case the operating mode of the vehicle after the predetermined period is expected to be shifted to the engine mode.

What is claimed is:

1. A control system for a hybrid vehicle having an engine and at least a pair of motors, the control system comprising
an electronic control unit configured to:
select an operating mode of the vehicle from a first mode in which the vehicle is powered by the engine, a second mode in which the vehicle is powered by at least two of the motors while stopping the engine, and a third mode in which the vehicle is powered by smaller numbers of the motors than that under the second mode while stopping the engine;
carry out a motoring of the engine by a first motor when shifting the operating mode from the second mode or the third mode to the first mode, the first motor being configured to generate driving force under the second mode, and the first motor being configured not to generate driving force under the third mode;
estimate a vehicle speed after a predetermined period of time during propulsion of the vehicle under the third mode;
determine whether or not an operating point of the vehicle determined based on an estimated vehicle speed and a current driving force will enter into a region where the vehicle can be propelled only under the first mode; and
shift the operating mode directly from the third mode to the first mode while skipping the second mode, when the current operating point of the vehicle determined based on a current vehicle speed and the current driving force enters into an operating region where both of the second mode and the third mode are available and the operating point is expected to further enter into the region where the vehicle can be propelled only under the first mode.

2. The control system for the hybrid vehicle as claimed in claim 1, wherein the predetermined period of time includes a possible time period to propel the vehicle under the second mode.

3. The control system for the hybrid vehicle as claimed in claim 2, further comprising
an electric storage device that delivers electricity to the motors, wherein the predetermined period of time includes a possible time period of the electric storage device to continue to output the effective maximum power of the electric storage device to propel the vehicle under the second mode.

4. The control system for the hybrid vehicle as claimed in claim 3, wherein the possible time period of the electric storage device to continue to output an effective maximum power is determined based on one of a state of charge level of the electric storage device and a temperature of the electric storage device.

5. The control system for the hybrid vehicle as claimed in claim 1 wherein the electronic control unit is configured to estimate the vehicle speed after the predetermined period based on the current driving force, the current vehicle speed, and a current road gradient.

6. The control system for the hybrid vehicle as claimed in claim 1, wherein a boundary between the operating region where the third mode is selected and the operating region where one of the second mode and the third mode is selected is determined in such a manner that one of the motors is still allowed to increase an output torque of the one of the motors to compensate a reduction in the driving force resulting from cranking the engine by the first motor to shift the operating mode to the first mode.

7. The control system for the hybrid vehicle as claimed in claim 1, wherein
the vehicle is configured to be propelled by a larger driving force at a higher speed under the first mode than under the second mode and the third mode and
the vehicle is configured be propelled by a larger driving force at a higher speed under the second mode than under the third mode.

8. The control system for the hybrid vehicle as claimed in claim 1, further comprising:
a power distribution device including at least three rotary elements that includes a first rotary element; and
an engagement device that halts a rotation of the first rotary element, wherein any one of the motors that generates driving force under the second mode and the third mode is connected to any of rotary element other than the first rotary element.

9. The control system for the hybrid vehicle as claimed in claim 8, wherein the first motor is connected to the first rotary element.
